(19) United States
(12) Patent Application Publication
(10) Pub. No.: US 2008/0038101 A1
(43) Pub. Date: Feb. 14, 2008

(54) Loading Compartment Floor for a Loading Compartment of a Motor Vehicle

(76) Inventor: Peter Klatt, Zell am Moos (AT)

Correspondence Address: KELLEY DRYE & WARREN LLP, 400 ALTLANTIC STREET , 13TH FLOOR, STAMFORD, CT, 06901, US

(21) Appl. No.: 11/762,387

(22) Filed: Jun. 13, 2007

(30) Foreign Application Priority Data
Jun. 16, 2006 (AT) A 1032/2006

(51) Int. Cl. B65G 67/02

(52) U.S. Cl. 414/345

(57) ABSTRACT

The invention relates to a loading compartment floor for a motor vehicle, with a conveyor system for loading and unloading a loading compartment of the motor vehicle, comprising a drive roller and a guide roller as well as a conveyor belt endlessly circulated around the latter. Disposed in the pulley regions of the conveyor belt is a sensor for controlling the drive roller. The loading compartment floor is disposed above a depression for a spare wheel and is mounted in the loading compartment by means of a bearing part so as to be displaceable between an open position releasing the depression and a closed position covering the depression.

### CROSS-REFERENCE TO RELATED APPLICATIONS

Applicant claims priority under 35 U.S.C. §119 of AUSTRIAN Patent Application No. A 1032/2006 filed on Jun. 16, 2006, which disclosure is incorporated herein in its entirety.

The references cited in this specification, and their references, are incorporated by reference herein in their entirety where appropriate for teachings of additional or alternative details, features, and/or technical background.

### BACKGROUND OF THE INVENTION

1. Field of the Invention

The invention relates to a loading compartment floor, or more particularly a moveable loading platform as a loading compartment floor in a motor vehicle.

2. Prior Art

Documents DE 298 07 772 U1, DE 100 19 645 A1, DE 197 09 114 A1 and DE 199 04 714 C2 disclose loading compartment floors of the generic type for a loading compartment of a motor vehicle, by means of which the manipulation, in particular the loading and unloading of the loading compartment is made significantly easier. To this end, a conveyor mechanism is provided in the loading compartment, comprising a frame with a drive roller and a guide roller mounted on it, as well as a conveyor belt endlessly circulating around them. The drive roller can be driven by means of an electric motor and is connected to the conveyor belt by friction, so that when a torque is applied to the drive roller, the cargo, for example a crate of drinks, a retail container, etc., can be moved relative to the loading compartment into a loading position. The motor-assisted loading and unloading process makes manipulation more comfortable for the operator. The electric motor is connected to a control unit for controlling the circulation direction of the conveyor belt during loading and unloading as well as the start-up and stopping operations. The conveyor system is disposed across the entire width of the loading compartment and extends between the rear seat and a loading opening at the rear of the motor vehicle.

In the case of one embodiment defined in patent specification DE 100 55 826 A1, a first conveyor system is mounted on the floor of the loading compartment and a second conveyor system is provided, on which a seat frame which is pivotable on a back rest of the rear seat is mounted so that when the back rest is in the pivoted position, the conveyor systems lie in one plane forming a continuous loading surface between the front seats and the loading opening at the rear. This increases the volume which can be accommodated in the loading compartment whilst affording comfortable loading and unloading of the loading surface.

Patent specification DE 20 32 958 A1 discloses a loading compartment floor for an omnibus, comprising a conveyor system for loading and unloading a loading compartment of the omnibus, which conveyor system has a frame, a drive roller and guide roller mounted in it as well as conveyor belt endlessly circulating round the latter. The drive roller is coupled with an electric motor, which is operated by means of a switch (control unit) in the region of the loading opening. Also provided in the loading compartment of the omnibus is an end switch, which switches the electric motor off when an item of cargo has reached the wall of the bodywork lying opposite the loading opening of the loading compartment. The major disadvantage of this system is that it relies on the skill of the operator to stop the cargo in an unloading position close to the loading opening in good time by means of the control unit. Incorrect operation can result in an item of cargo to be unloaded not being stopped in the unloading position in time and falling out of the loading compartment. This can result in damage to the cargo and injury to the operator.

Document DE 10 2004 051 622 A1 discloses a loading compartment floor for a luggage space of a motor vehicle, comprising several loading compartment floor elements accommodated in a module, which folds in the luggage space and can be pivoted upwards in order to make a depression extending in a plane below the loading compartment floor accessible.

### SUMMARY OF THE INVENTION

The underlying objective of the invention is to provide a loading compartment floor in a motor vehicle, which permits comfortable manipulation of a cargo item inside or on a loading compartment of the motor vehicle and reliable transport of a cargo item, and is distinctive due to its reliable and safe operating mode.

This objective is achieved on the basis of the features of a conveyor system containing a drive roller, a guide roller and a conveyor belt continuously wrapped around the drive and guide rollers, and a means of detecting a loading and an unloading position of said conveyor system and a means of controlling the drive rollers, which are operatively disposed in pulley regions of the conveyor belt. The conveyor belt forms a transport plane or load carrying surface.

An embodiment provides sensors disposed in the pulley regions to detect the cargo is detected such that the conveyor system is reliably switched off if the cargo has reached either the loading position or the unloading position. The sensors assume the function of an end position switch, thereby ensuring that the item of cargo to be moved into the loading or unloading position is stopped in a controlled and correctly positioned manner in the loading compartment by controlling the drive roller in a specific way.

Another embodiment provides the sensors respectively disposed in a radial gap region between a frame of the conveyor system and an external face of the conveyor belt facing away from the drive and guide rollers, such that the sensors are protected from external environmental influences because the frame acts as a protection device for the sensors and a very compact design of the conveyor system is achieved.

One embodiment may provide that the presence of an item of cargo in the loading or unloading position can be detected without contact as different mounting options for the sensors and the variants may be selected depending on the loading compartment volumes available.

An embodiment of the invention provides sensors comprising laser or infrared sensor arrays capable of projecting a scanning beam transversely across the conveyor system in the direction of the rotation axis of the drive and guide rollers, the switch block is able to assume the function of an end position switch and fulfill a safety function. The latter is achieved due to the fact that the switch surface projects into the gap region when the sensor is in the activated and non-activated switch position so that the remaining gap between the external face of the conveyor belt and the switch surface is of a width which is shorter than a width of an operator's finger. This reliably prevents any risk of injury to the operator by trapping, crushing or severing of a finger. The loading compartment floor proposed by the invention therefore also meets stringent requirements in terms of safety aspects.

Another embodiment provides that the sensors are integrated in the frame or secured to it by means of mounting holders or secured in the loading compartment.

Other embodiments provide a loading compartment floor wherein every sensor comprises a switch block projecting from the transport plane or load carrying surface of the conveyor belt; or wherein a switch block surface projects into the gap region. The switch block is able to pivot relative to the frame results in a reliable switching function, even in the event of vibrations as an item of cargo reaches the loading or unloading position.

Another embodiment is directed to stops in the form of damping elements in the region of the front and rear edges to at least partially absorb impact energy on impact with the item of cargo wherein the damping elements comprise deformable switch blocks including a switch body made from an elastically flexible, reversible plastic, as for example, a thermoplastic, such that a reliable switching function is guaranteed by the elastically deformable switch surface, and the switch body, which is at least partially made from an elastically deformable plastic, acts as a damping element, which is capable of absorbing at least some of the impact energy induced by an item of cargo hitting the switch surface by converting it into deformation energy, so that the item of cargo is decelerated and moves without backlash and particularly softly into the final loading or unloading position. The amount of energy to be absorbed can be set on the basis of the size and/or material of the switch body.

An embodiment the switch block extends essentially continuously across the width of the conveyor belt which has proved to be of advantage because, irrespective of the position in which the item of cargo is placed on the loading surface, the function of the end position cut-off is fulfilled.

Another embodiment is provided whereby the top strand of the conveyor belt is supported flat on a slide surface so that heavy items of cargo can also be moved by means of the conveyor belt in the loading compartment between the loading and unloading position without damaging the conveyor belt, even though there is a heavy load at one point. Due to the fact that the conveyor belt is supported in a flat arrangement, it does not need to have any specific tearing resistance.

In another embodiment, a sound-absorbing component, out of wood, a wood-based material, plastic or a composite material, such as a composite board, is secured to the frame between said top strand and a bottom strand of the conveyor belt; or a sound-absorbing component forms a slide surface for a top and/or bottom strand of the conveyor belt or is connected to the slide surface for a top and/or bottom strand of the conveyor belt.

Another embodiment provides the sound-proofing disposed between the top strand and the bottom strand of the conveyor belt, thereby reducing driving noise in the motor vehicle interior to a minimum and creating a pleasant acoustic ambient atmosphere for the occupants. Moreover, this arrangement results in a very compact conveyor system.

The further embodiment provides that the drive roller is coupled with an electric motor disposed inside the drive roller. Integrating the electric motor and brake mechanism inside the drive roller results in optimum protection against external environmental influences because the drive roller itself serves as a protective device for the electric motor and brake mechanism. The drive roller arrangement is distinctive due to a long service life, higher performance and a simple installation, reversing mode and dynamic brake.

The embodiment defined by the electric motor connected to a control unit for controlling the circulation direction of the conveyor belt, which in turn is connected to a control unit of a motor vehicle power system, makes the conveyor system comfortable to control and enables a selective change in the direction of circulation of the conveyor belt.

Another embodiment provides a motor vehicle with a loading compartment wherein the frame and the conveyor belt with mutually engaging guide elements with complementary, such as wedge-shaped or semicircular guide surfaces, of which the first guide element on the frame is assigned to the top strand of the conveyor belt and extends continuously in parallel with the circulation direction between the drive and guide rollers, and the second guide element on the conveyor belt extends continuously in the circulation direction across the entire conveyor belt length. This arrangement provides that because the conveyor belt is positively guided along guide elements on the frame, even when turning corners and carrying items of cargo with a high weight so that the conveyor belt is retained relative to the frame and the conveyor belt is not able to shift undesirably in the direction of the rotation axis of the drive or circulating roller. This prevents any backlash of the conveyor belt and as a result prevents an item of cargo from tipping sideways, and also ensures that the longitudinal edges of the conveyor belt are retained at a distance from the longitudinal members when the conveyor system is switched on, which means that there is very little wear when the conveyor system is in operation. Furthermore, the conveyor belt runs very quietly, even when operated at high circulation speeds. Since the drive and guide rollers (pulley unit) are manufactured without guide grooves and the conveyor belt lies flat on the support surface disposed between the guide elements, the loading compartment floor may be designed with a very low construction height. Furthermore, inexpensive drive and guide rollers can be used.

An embodiment of the motor vehicle is disclosed wherein a depression is provided in the loading compartment in a plane extending underneath the loading compartment floor, preferably for a spare wheel, and the loading compartment floor is mounted in the loading compartment by means of a bearing part so that it can be moved between an open position releasing the depression and a closed position covering the depression. The arrangement provides the ability of the loading compartment floor to move relative to the depression so that the depression can be a can be accessed.

One embodiment of the motor vehicle provides that the loading compartment floor can be pivoted between the open and closed position, thereby making manipulation easier.

Due to the embodiment of the motor vehicle wherein the drive roller is disposed at the same end as the bearing shaft, provides that the drive roller, which is of a higher weight than the guide roller, can be disposed coaxially with the pivot or bearing axis or eccentrically with respect to the bearing or pivot axis at the same end of the loading compartment floor, which means that little force is needed to move out of the closed position into the open position.

Finally, the embodiment of the motor vehicle wherein the loading compartment floor is mounted in a stationary bearing part in the loading compartment so as to be displaceable in a plane extending in parallel with the transport plane is advantageous because the loading compartment floor provided by the invention may also be used in sports cars with a relatively low internal height.

### BRIEF DESCRIPTION OF THE DRAWINGS

The invention will be explained in more detail below with reference to examples of embodiments illustrated in the appended drawings. Of these:

FIG. 1 is a simplified diagram showing a perspective view of a rear part of a motor vehicle, in particular a passenger vehicle, with the loading compartment floor proposed by the invention;

FIG. 2 shows the loading compartment floor illustrated in FIG. 1 with a conveyor system for loading and unloading a loading compartment of the motor vehicle;

FIG. 3 is an exploded diagram of the conveyor system illustrated in FIG. 2;

FIG. 4 shows the conveyor system in section along line IV-IV indicated in FIG. 2;

FIG. 5 shows the conveyor system in section along line V-V indicated in FIG. 2;

FIG. 6 is a simple diagram showing a plan view of the conveyor system with the conveyor belt removed and the support surface removed;

FIG. 7 is a view on a larger scale showing a detail from FIG. 5 with a view onto a longitudinal face of the conveyor system with the guide elements on the frame and the conveyor belt;

FIG. 8 is a view on a larger scale showing a detail from FIG. 4 from a front end of the conveyor system with a first embodiment of a sensor in the non-activated switch position;

FIG. 9 shows the sensor illustrated in FIG. 8 in the switch position activated by the item of cargo;

FIG. 10 is a simplified diagram in section showing a detail of the front end of the conveyor system with a different embodiment of a sensor in the non-activated switch position;

FIG. 11 is a view on a larger scale showing a detail from FIG. 10 of the pulley region with the sensor in the switch position activated by the item of cargo;

FIG. 12 is a simplified diagram in partial section showing a side view of a detail of a loading compartment and the loading compartment floor pivoted into the closed position;

FIG. 13 is a simplified diagram in partial section showing a side view of a detail of a loading compartment and the loading compartment floor pivoted up into the open position.

### DETAILED DESCRIPTION OF PREFERRED EMBODIMENTS

Firstly, it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc., relate to the drawing specifically being described and can be transposed in terms of meaning to a new position when another position is being described.

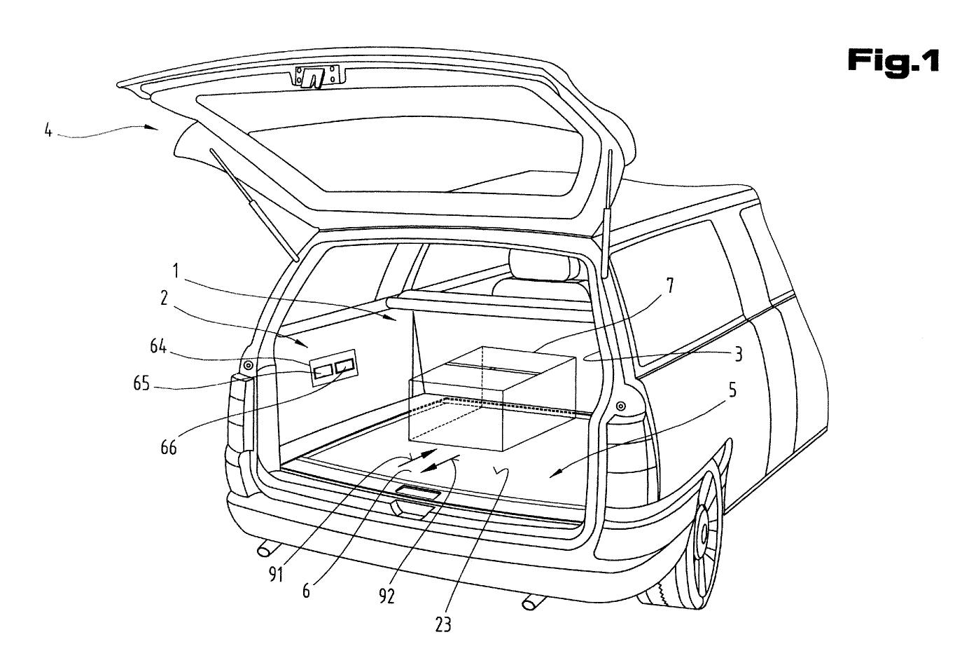

The part of the motor vehicle schematically illustrated in FIG. 1 with its rear region, in particular a passenger vehicle, has a luggage or loading compartment 2 disposed behind a rear seat 1, which can be loaded and unloaded through a rear loading opening 3 at the rear. The loading opening 3 can be closed by means of a rear door 4 and is opened by pivoting the rear door 4 upwards. In order to make the volume which the loading compartment 2 can accommodate bigger, the seat cushion and backrest of the rear seat 1 can be pivoted or folded.

At the bottom towards the vehicle floor, the loading compartment 2 is bounded by a loading compartment floor 5 proposed by the invention, which incorporates a conveyor system 6 for loading and unloading the loading compartment 2 with one or more items of cargo 7. Items of cargo 7 that are heavy in terms of their weight can be effortlessly manipulated by means of this loading compartment floor 5.

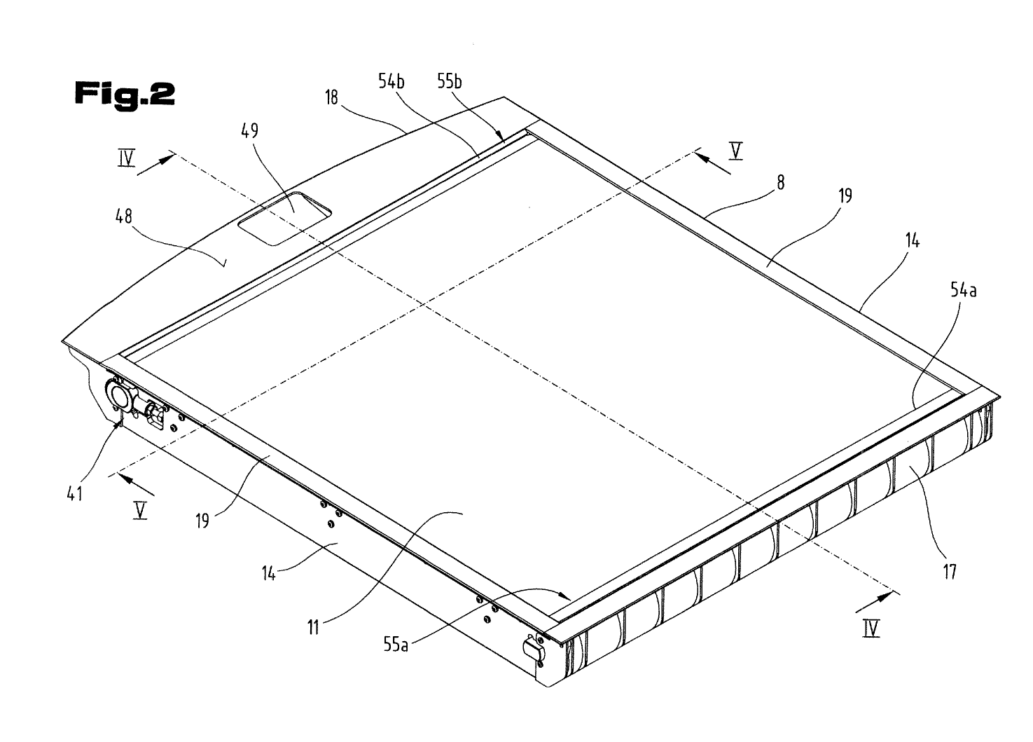

Different views of this conveyor system 6 are illustrated in FIGS. 2 to 13. It comprises a frame 8, a drive roller 9 and guide roller 10 mounted on it so as to rotate, a conveyor belt 11 endlessly circulating round the drive and guide rollers 9, 10, a support surface 12 as well as a cover 13. As viewed in the driving direction, the drive roller 9 is disposed at the front end of the conveyor system 6 and the guide roller 10 is disposed at a rear end of the conveyor system 6.

The frame 8 has parallel longitudinal members 14 spaced at a distance apart in the vehicle longitudinal direction and cross-members 15 connecting them, terminal members 17, 18 at the front and rear end of the conveyor system 6 oriented parallel with a rotation axis 16 of the drive and guide rollers 9, 10 as well as bridging sections 19. The longitudinal members 14, cross-members 15 and bridging sections 19 are extruded sections made from aluminum or plastic sections made by an extrusion process or sheet metal sections. The terminal members 17, 18 are made from plastic by an injection molding process, for example.

The drive and guide rollers 9, 10 have a cylindrical casing and terminal ends closing it off at both ends and are each retrained on a stationary shaft, the shaft portions 20 of which extending axially beyond the terminal ends are mounted in shaft mounts 21 provided on the longitudinal members 14 in the region of their ends. The shaft mounts 21 are formed by slot-shaped cutouts and the external contour of the shaft portions 20 is adapted to the contour of the cutouts so that the shafts of the drive and guide rollers 9, 10 are retained in the frame 8 and prevented from rotating.

The motor-driven endless conveyor belt 11 forms a running surface on its internal face and a loading surface 23 on its external face on the top strand 22, which is displaceable in the vehicle longitudinal direction, for depositing at least one item of cargo 7. The loading surface 23 defines a transport plane or load carrying surface of the conveyor system 6 and extends essentially across the loading compartment width, as illustrated in FIG. 1. The top strand 22 of the conveyor belt 11 extending between the drive and guide rollers 9, 10 lies with its internal face or running surface sliding on the support surface 12, and the upwardly directed free surface between the longitudinal members 14 forms a slide surface 24. The slide surface 24 is formed by an antifriction coating or lacquer coating of plastic, with which the surface is coated. Due to the flat seating or support of the top strand 22 on the slide surface 24, heavy items of cargo 7 with no base surface can be handled without any difficulty.

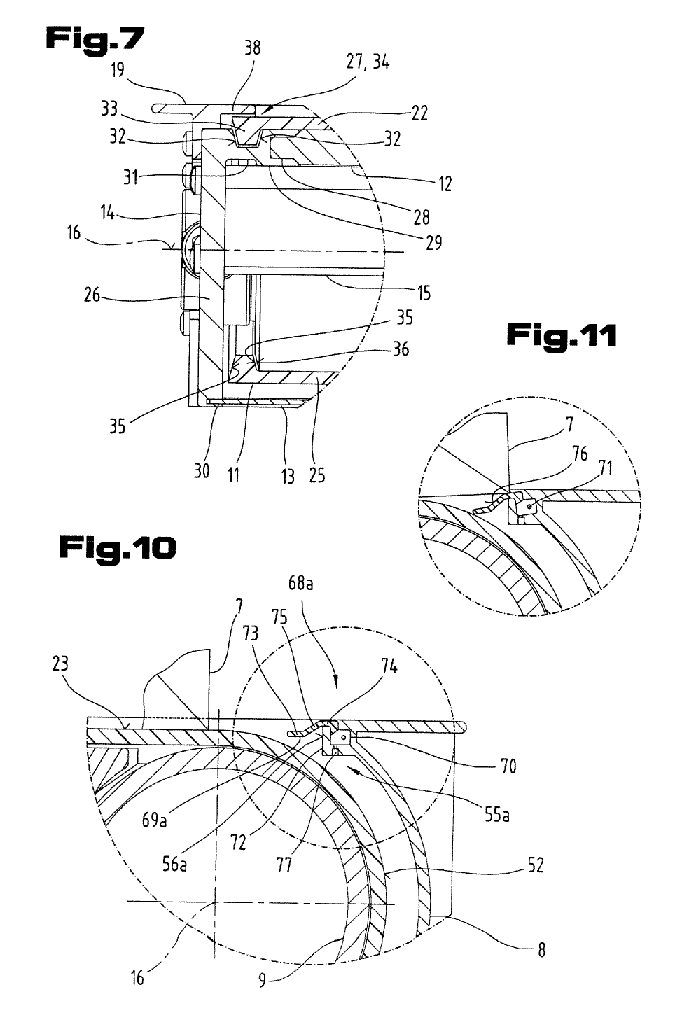

The support surface 12 is provided in the form of a support plate, which is retained on the frame 8 between the top strand 22 and a bottom strand 25 of the conveyor belt 11 by a fixing mechanism, although this is not illustrated in FIGS. 5 and 7.

In another embodiment, the support surface 12 may have a sound absorbing component made from wood, wood-based material, plastic or a composite material, in particular composite board comprising several plies, which is designed as a plate vibrator (resonance absorber) or plyboard resonator. The sound absorbing component is preferably designed as a spring-mass system with a high degree of sound absorption.

Sound may also be absorbed using porous materials, for example open-pored foams, which convert sound energy into thermal energy due to friction caused by air particles moving through the pores. The materials are of natural and organic origin.

Provided on the bottom face of the conveyor system 6 is the board shaped cover 13, which is retained on the frame 8 by a fixing mechanism that will be described in detail below, as may also be seen from FIGS. 5 and 7.

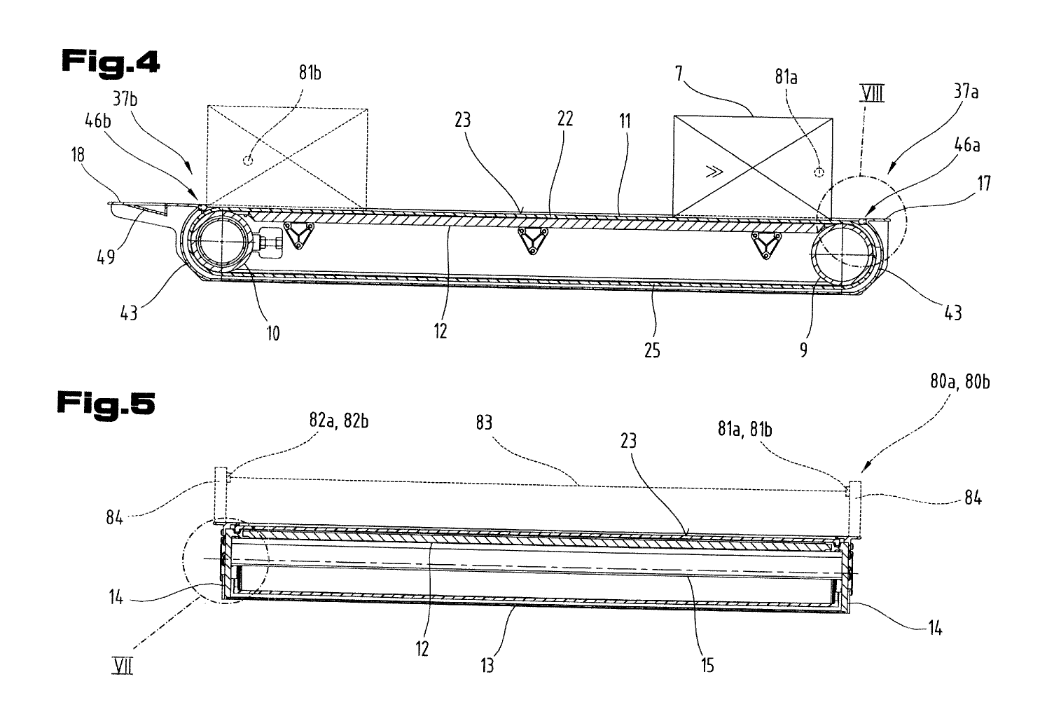

The longitudinal members 14 extending in the circulation direction of the conveyor belt 11 have a wall 26 projecting perpendicular to the loading surface 23 and a respective guide element 27 on their mutually facing internal faces between a bottom and top edge of the longitudinal members 14, as well as the fixing mechanisms for the support surface 12 and the cover 13. The fixing mechanisms for the support surface 12 are provided in the form of oppositely lying, groove-type mounting slots 28, which are U-shaped in particular, disposed in a plane parallel with the loading surface 23, formed in projections 29 projecting out from the internal faces. The fixing mechanisms for the cover 13 are provided in the form of oppositely lying, groove-type mounting slots 30 in a plane parallel with the loading surface 23, which are recessed directly into the internal faces of the longitudinal members 14. The support plate and the cover 13 are disposed in the mounting slots 28, 30 between the longitudinal members 14 and are positively supported by the mounting slots 28, 30 by means of their edges. The board*shaped cover 13 extends between the longitudinal members 14 and terminates flush with the terminal members 17, 18, as may be seen from FIGS. 4 and 5. The support plate extends between the longitudinal members 14 and almost across the entire length of the conveyor system 6, with its terminal edges being disposed at only a slight distance from the outer peripheral surface of the drive and guide rollers 9, 10, as illustrated in FIG. 4.

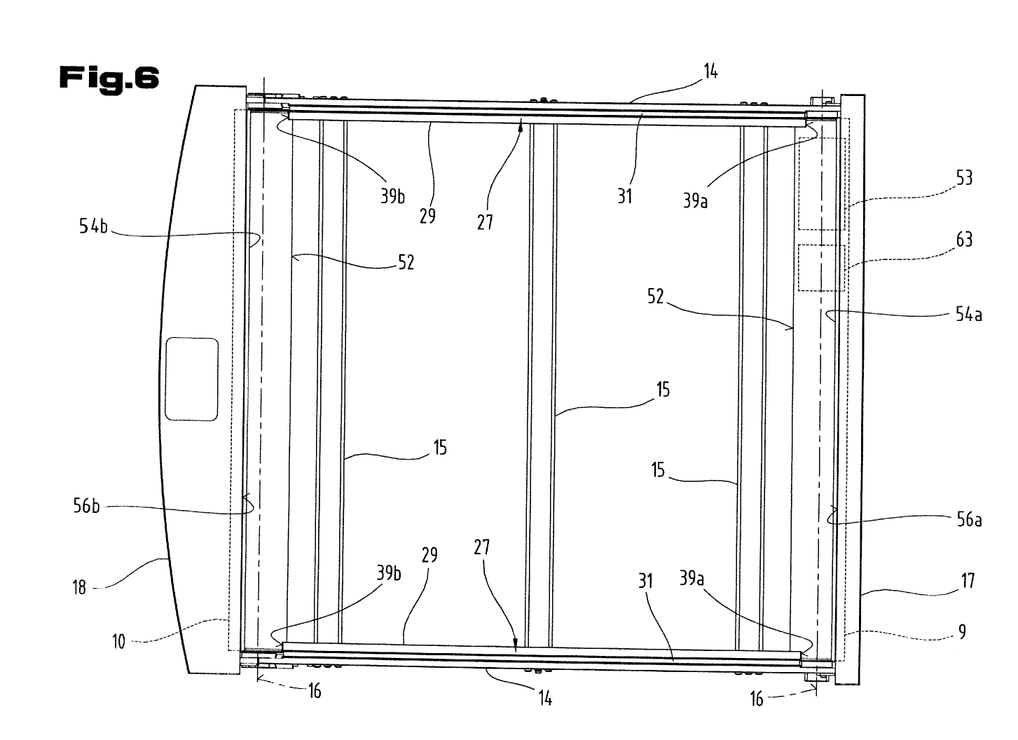

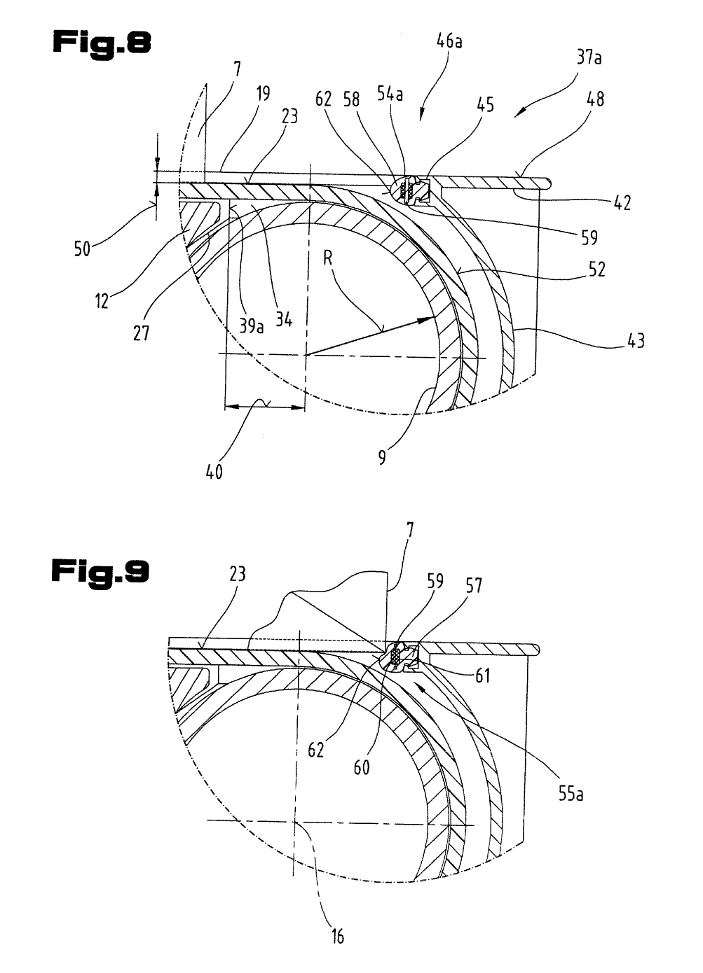

As illustrated in FIG. 6, the guide elements 27 of the longitudinal members 14 are disposed on the two sides of the drive and guide rollers 9, 10 and support surface 12 (FIG. 7) and extend respectively in the direction parallel with the circulation direction of the conveyor belt 11 between the drive and guide rollers 9, 10. The guide elements 27 respectively have a guide rail 31 with mutually angled guide surfaces 32 (see FIG. 7). The guide surfaces 32 delimit a guide groove formed in the top face of the projection 29. The angle subtended by the guide surfaces 32 is between 25° and 35°, for example 30°. As indicated in FIG. 8, the terminal ends 39a, 39b of each guide rail 31 extend into the pulley regions 37a, 37b at least as far as a distance 40 corresponding to half the external diameter (external radius “R”) of the drive and guide rollers 9, 10 but at most as far as the rotation axes 16 of the drive and guide rollers 9, 10.

As may also be seen from FIGS. 5 and 7, the endless conveyor belt 11 has a belt-shaped support part with a rectangular cross-section and guide parts 33 extending downwards in a profiled arrangement with a trapezium shaped cross-section on its internal face remote from the transport plane spaced apart from one another essentially around the length of the drive and guide rollers 9, 10. The guide parts 33 are preferably disposed on the internal face along the side edges of the conveyor belt 11. The guide parts 33 form guide elements 34 and each have mutually angled guide surfaces 35 which complement the angled guide surfaces 32 of the oppositely lying guide rails 31. The angle subtended by the guide surfaces 35 is between 25° and 35°, for example 30°. Due to the guide elements 27, 34 engaging with one another in a sliding action, an excellent guide system is provided for the conveyor belt 11.

Although not illustrated, it would also be possible for the endless conveyor belt 11 to be provided exclusively with one guide element 34, in which case one guide element 27 only would be disposed in the plane of symmetry of the conveyor system 6. To this end, the support plate would be provided with the guide groove for the guide element 34 of the conveyor belt 11.

Under a normal operating load, it is sufficient if the top strand 22 of the conveyor belt 11 is vertically and laterally guided in the guide rails 31, but it may also be of advantage if the bottom strand 25 of the conveyor belt 11 is also laterally guided. This will make the movement of an item of cargo 7 between a loading position close to the loading opening 3 and an unloading position close to the rear seat 1 or vice versa even quieter.

The conveyor belt 11 may be laterally guided at the bottom strand 25 and/or in the pulley regions 37a, 37b between the top and bottom strand 22, 25 by means of the drive and/or guide rollers 9, 10, which are in turn provided with conically tapering guide surfaces 36 on the terminal ends in the direction of the shaft portions 20 projecting out from them. These are provided in the form of caps (not illustrated) inserted in the ends of the cylindrical casing, for example. The guide surfaces 36 complement the guide surfaces 32 adjacent to the drive and/or guide rollers 9, 10. The guide elements 34 engage round the terminal ends of the drive and guide rollers 9, 10. The guide surfaces 32 respectively adjacent to the drive and guide rollers 9, 10 extend at a tangent to the frustoconical guide surface 36 and the angle of inclination subtended by a vertical line and the guide surface 32 corresponds to the angle of inclination subtended by a vertical line and the guide surface 36. As a result, the guide parts 33 of the conveyor belt 11 are transferred into the inlet side ends of the guide rails 31 without experiencing any torsion in the pulley regions 37a, 37b.

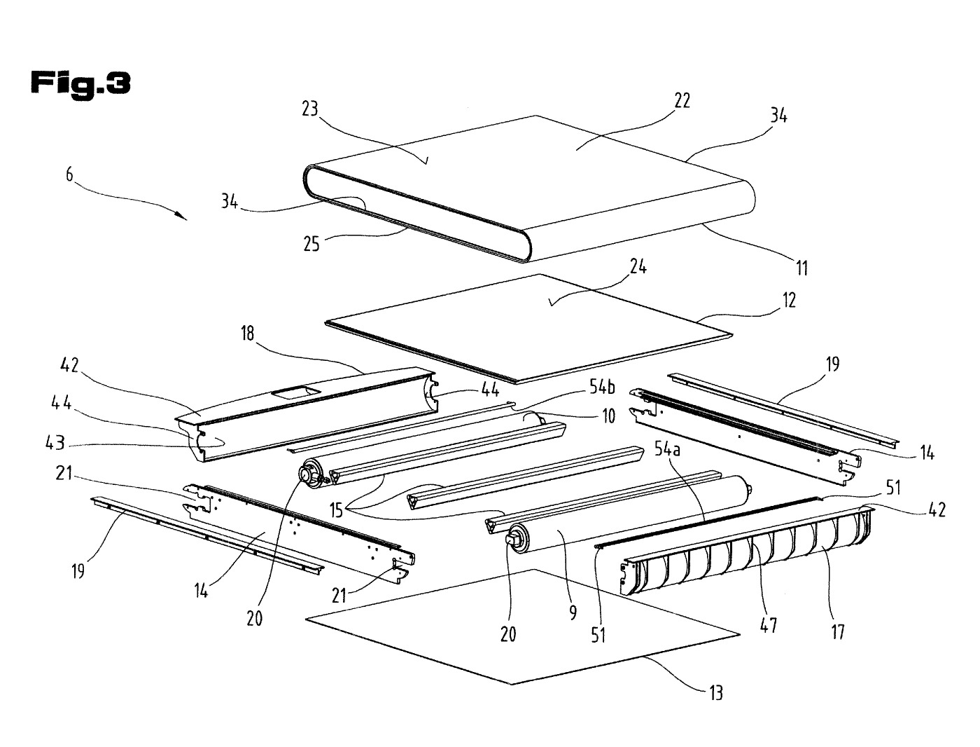

As may also be seen from FIGS. 2 and 3, the guide roller 13 is also designed as a clamping roller and its shaft is mounted in the shaft mount 21 so that it is displaceable on a clamping mechanism 41 relative to the longitudinal members 14. As a result of this clamping mechanism 41, the guide roller 10 is subjected to a clamping force directed away from the drive roller 9 so that at least the top strand 22 of the conveyor belt 11 lies with its internal face flat on the slide surface 24 and length tolerances are compensated. Such clamping mechanisms 41 may be self*adjusting or alternatively may be readjusted in the frame manually during maintenance work. The person skilled in the art will be familiar with such clamping mechanisms 41.

As may be seen from FIGS. 5 and 7, bridging sections 19 with an approximately Tshaped cross-section are secured to the top face of the longitudinal members 14 so that the horizontal legs 38 extending towards one another extend across the longitudinal edges of the conveyor belt 11 and sit with a slight clearance above the transport plane.

The terminal members 17, 18 are releasably connected to the longitudinal members 14 at the front and rear end of the conveyor system 6 by connecting elements, for example screws, and respectively have a cover portion 42 lying in the plane parallel with the loading surface 23, and adjoining this a concave terminal portion 43 as well as connecting flanges 44 at the oppositely lying ends in the direction of the rotation axis 16. The terminal member 17, 18 extends across the entire width of the conveyor system 6 and is bounded at its end by the connecting flanges 44. The radius of curvature of the concave terminal portion 43 is bigger than the external radius “R” of the drive and guide rollers 9, 10 by a radial gap. In the transition region between the cover and terminal portions 42, 43, likewise extending across the entire width of the conveyor system 6, is a preferably undercut mounting groove 45 for sensors 46a, 46b to be described below, as illustrated in FIG. 8. The sensors 46a, 46b detect the presence of an item of cargo 7 either in the loading or unloading position and this is evaluated by an evaluation unit.

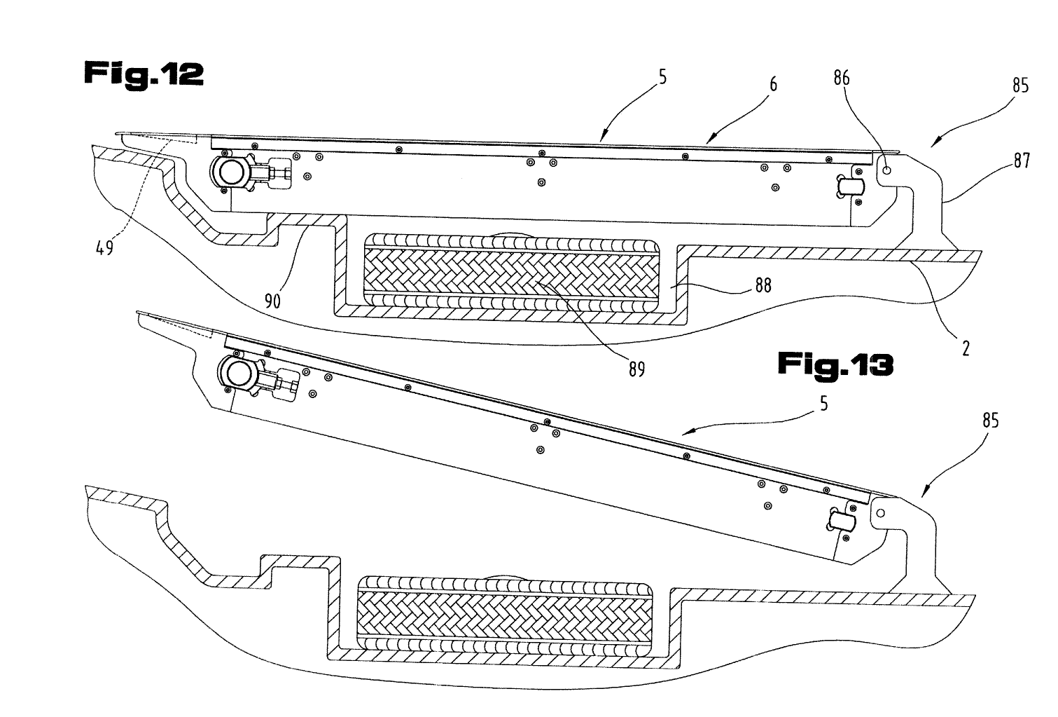

Disposed on the external face of the terminal members 17, 18 in the longitudinal direction are reinforcing ribs 47 spaced at a distance apart and extending between the cover and terminal portions 42, 43. These impart a high torsion and bending resistance to the terminal members 17, 18 so that when loading and unloading an item of cargo 7 to and from the loading compartment 2, a heavier item 7 can also be placed on a top face 48 on the cover portion 42. Accordingly, the cover portion 42 of the rear terminal member 18 adjacent to the loading opening 3 (see FIG. 1) may form a support surface on the top face 48 extending parallel with the loading surface 23. As may also be seen from the drawing, the rear terminal member 18 is provided with a grip depression 49 recessed into it at the cover portion 42, by means of which the conveyor system 6 can be ergonomically and comfortably moved between a folded closed position, illustrated in FIG. 12, and a folded open position, illustrated in FIG. 13.

As illustrated in FIG. 8, the top face 48 or support surface of the rear terminal member 18 is offset from the loading surface 23 by a distance 50 in the vertical direction, making it easy for the item of cargo 7 to be moved into either the loading position or unloading position. The distance 50 is preferably 4 to 6 mm.

As may be seen from a comparison of FIGS. 4 and 6, a sensor 46a, 46b is respectively provided in the pulley regions 37a, 37b of the conveyor belt 11, by means of which a reversible drive motor coupled with the drive roller 9, in particular an electric motor 53 schematically indicated in FIG. 6, especially a brushless dc motor, can be activated. The electric motor 53 acts on a drive roller 9 connected to the conveyor belt 11 by a friction force and drives the drive roller 9 selectively in the clockwise or counterclockwise direction. The electric motor 53 is connected to a control unit, although this is not illustrated, which has a controller and is therefore able to fulfill different control functions. For example, by evaluating the motor current an overload circuit or cut-off switch of the electric motor 53 may be activated if an item of cargo 7 becomes blocked or if the item of cargo 7 fails to reach the unloading or loading position. Speed ramps may also be run by the regulated electric motor 53, the advantage of which is that the circulation speed of the conveyor belt 11 can be regulated so that it is minimized shortly before reaching the unloading or loading position, in order to reduce impact energy if the item of cargo 7 hits the switch block 46a, 46b; 69a, 69b or runs against a front or rear edge 56a, 56b on the frame 8.

In the embodiment illustrated as an example, the sensors 46a, 46b have a switch block 54a, 54b projecting out from the transport plane, which is disposed in the gap region 55a, 55b between the external face 52 or the external peripheral surface of the conveyor belt 11 and a front and rear edge 56a, 56b (see FIG. 6) parallel with the rotation axis 16 on the terminal member 17, 18.

The switch blocks 54a, 54b respectively extend parallel with the rotation axis 16 between the longitudinal members 14 across the entire width of the conveyor belt 11 and are replaceably mounted at the ends by means of plug-in pins 51 and/or between the latter by means of a fixing element 57, in particular a positively connecting element engaging in the mounting groove 45 or an elastically deformable catch or snapper element or similar, on the frame 8, in particular on the terminal member 17, 18. The plug-in p ins 51 have a bore extending through them, through which the electric cables are run to the switch blocks 46a, 46b, which will be described in more detail below.

The switch blocks 54a, 54b comprise a switch body 58 with a switch compartment 59 integrated in it and electrically conducting contact regions 60, 61 separated from one another by the latter, as well as an elastically deformable switch surface 62 facing the conveyor belt 11 and projecting into the gap region 55a, 55b. The advantage of this is that the switch body 58, made from elastically deform able plastic, in particular thermo setting elastomer, simultaneously acts as a damping element for absorbing impact energy if an item of cargo 7 runs against the switch surface 62. The impact energy is therefore converted into deformation energy.

The switch surface 62 is disposed facing the drive and guide rollers 9, 10 and is of a convex design formed by the elastically deformable, reversible switch body 58. Although not illustrated, the contact regions 60, 61 are connected to a current source by power cables. Even only a light pressure on the switch blocks 54a, 54b caused by an item of cargo 7 colliding with them will cause the switch surface 62 and the switch compartment 59 to be elastically deformed, so that the contact regions 60, 61 move into abutment with one another and an electric switch signal is transmitted to an evaluation unit (not illustrated), which in turn forwards an electric control signal to the electric motor 53 and activates the drive roller 9. Once the item of cargo 7 reaches a loading position, as illustrated in FIG. 9, or an unloading position, as indicated by broken lines in FIG. 4, the switch block 54a; 54b is activated due to the elastic deformation of the switch surface 62, a control signal is generated by the evaluation unit and the electric motor 53 activated so that the circulating movement of the conveyor belt 11 with the item of cargo 7 deposited on the conveyor belt 11 are stopped from moving further. The switch block 46a, 46b automatically rebounds from the activated position illustrated in FIG. 9 in which the switch body 58 is deformed, into the non-activated position illustrated in FIG. 8, in which the switch body 58 is not deformed, when the item of cargo 7 is moved away from the switch block 46a, 46b again.

When the switch block 54a, 54b is activated by the item of cargo 7 running against it and reaches either the loading position or the unloading position, a brake mechanism 63 schematically indicated by broken lines in FIG. 6 is preferably activated in order to block the conveyor belt 11. The brake mechanism 63 has an electromechanical or electromagnetic brake, which is activated by the evaluation or control unit by an appropriate electric brake signal. The evaluation unit is connected to the control unit.

In a preferred embodiment, both the electric motor 53 and the brake mechanism 63 are integrated in the drive roller 9 and are disposed coaxially with the rotation axis 16, as schematically indicated by broken lines in FIG. 6.

The brake mechanism 63 remains in its engaged brake position and locks the drive roller 9 until a forward switch 65 on a control unit 64 illustrated in FIG. 1 for moving the item of cargo 7 from the rear end of the conveyor system 6 in the direction towards the front end of the conveyor system 6 (loading position) or a reverse switch 66 for moving the item of cargo 7 from the front end of the conveyor system 6 in the direction towards the rear end of the conveyor system 6 (unloading position) is activated by an operator, not illustrated. The conveyor belt 11 may be driven via the control unit 64 selectively in the loading direction—indicated by arrow 91—or in the unloading direction—indicated by arrow 92. When the forward switch 65 or reverse switch 66 is activated, the brake mechanism 63 is moved into a disengaged base position. The control unit 64 is mounted on the wheel housing of the motor vehicle and is readily accessible to the operator.

When the brake mechanism 63 is in the non-activated switch state, it is advantageously always in its engaged brake position and is not moved into the disengaged basic position in which the conveyor belt 11 is driven until the forward switch 65 or reverse switch 66 is activated. This reliably avoids any undesirable shifting of the item of cargo 7 when it is in the loading position or unloading position. The braking moment is selected so that both in the case of positive and negative acceleration, in particular during strong braking maneuvers, there is no undesirable movement of the loading surface 23 and shifting of the item of cargo 7 against the acceleration force.

In order to prevent a relative movement between the item of cargo 7 and loading surface 23 even if there is a high negative or positive acceleration, the conveyor belt 11 has a high coefficient of static friction at its external face directed towards the item of cargo 7 or has a high surface roughness, in particular profiling on its surface. This ensures a reliable hold for an item of cargo 7 placed on the conveyor belt 11. For example, the external face 52 of the conveyor belt 11 is provided with a carpet, not illustrated, which is adapted in terms of color and quality to the other fittings of the motor vehicle interior. The coefficient of static friction of the internal face of the conveyor belt 11 facing the drive and guide rollers 9, 10, on the other hand, is lower than the coefficient of static friction of the top face 52 of the conveyor belt 11 facing the cargo 7, so that the conveyor belt 11 driving the cargo 7 with it is able to slide across the slide surface 24 with low friction. The conveyor belt 11 is essentially driven by the drive roller 9 without any slip.

FIG. 10 is a diagram on a larger scale schematically illustrating a detail of one end of the conveyor system 6 with a different embodiment of the sensor 68a, 68b. The sensor 68a, 68b is in turn form by a switch block 69a, 69b extending across the width of the conveyor belt 11, which, unlike the embodiment described in connection with the previous drawing, is preferably mounted on the pivotable bearing parts 70 disposed at oppositely lying ends in the direction of the rotation axis 16 on shaft stubs 71 parallel with the rotation axis 16 so as to be pivotable on the frame 8. The shaft stubs 71 are respectively provided in the form of a shaft body 72 integrally formed in the region of the connecting flange 44 of the terminal members 17, 18. The switch block 69a, 69b connects the pivot parts 70 and is formed by an angled section which, when the mounting section portion 73 is in the non-activated position in or slightly below the transport surface 23 and parallel with it, comprises a support section portion 74 parallel with the latter and a switch section portion 75 connected to it.

The switch section portion 75 of the switch block 69a, 69b has an inclined switch surface 76 in the circulation direction of the conveyor belt 11, and projects forward into the gap region 55a, 55b between the front edge 56a and rear edge 56b of the terminal members 17, 18 and the external face 52 of the conveyor belt 11 or extends into a displacement path of the item of cargo 7 bounded by the front and rear edges 56a, 56b of the frame 8. The transport surface 23 and switch surface 76 subtend an angle of between 110° and 160°.

The switch block 69a, 69b can be moved between the non-operating position illustrated in FIG. 10 and the operating position illustrated in FIG. 11. In the outwardly deflected operating position, a switch 77 is activated via the switch block 69a, 69b, in particular the pivot part 70, and it transmits an electric switch signal to the evaluation unit, which in turn activates the electric motor 53 of the drive roller 9 and gently stops the conveying movement of the item of cargo 7 exactly at the loading position or unloading position. The electric switch 77 assigned to the operating position is mounted on or integrated in the frame 8 and is connected to the evaluation or control unit. Once the loading position or unloading position is reached, even a light pressure on the switch block 69a, 69b due to an item of cargo 7 hitting it will cause the switch block 69a, 69b to be moved downwards into the operating position and, as described above, the brake mechanism 63 is activated and locks the drive roller 9. The cargo 7 is supported on the support section portion 74 and runs gently against the front or rear edge 56a, 56b when the item of cargo 7 reaches the loading or unloading position. The front or rear edges 56a, 56b act as stops, which limit the loading surface in the circulation direction of the conveyor belt 11 and/or incorporate the damping element disposed separately from the sensor 68a, 68b for absorbing impact energy when an item of cargo 7 runs against it. The damping elements may be provided in the form of a buffer made from elastically flexible, reversible plastic, such as elastomeric plastic for example, or rubber and similar, or by means of a compressible medium, such as buffers filled with air, gas, oil and similar, or an industrial damper filled with hydraulic oil (hydraulic damper).

The ability of the switch block 69a, 69b to move represents one of many possible ways of obtaining a relative movement of the switch block 69a, 69b with respect to the frame 8. The essential aspect is that the switch block 69a, 69b based on this embodiment can be displaced between the non-activated non-operating position and the operating position in order to generate a switch signal and detect the presence of an item of cargo 7 in the manner described above.

A different arrangement of sensors 80a, 80b is also indicated by broken lines in FIGS. 4 and 5, which are mounted on the frame 8 or in the loading compartment 2 close to or in the respective gap region 55a, 55b on the body of the motor vehicle. The sensors 80a, 80b may replace the sensors 46a, 46b; 68a, 68b mounted in the gap region 55a, 55b or may be provided in addition to these sensors 46a, 46b; 68a, 68b, or the sensors 46a, 46b in the gap region 55a, 55b are replaced by the sensors 80a, 80b. The sensors 80a, 80b are provided in the form of an optoelectronic sensor array, in particular a laser or infrared sensor array, and are connected to the control unit. The sensor arrays each have a light sensor 81a, 81b and a reflector 82a, 82b lying opposite it in the direction extending transversely to the longitudinal extension of the conveyor system 6, which reflects back the scanning beam 83 directed by the light sensor 81a, 81b transversely across the conveyor system 6 if no item of cargo 7 is in the loading or unloading position. If, on the other hand, the scanning beam 83 is interrupted and is not reflected back to the light sensor 81a, 81b, this means that an item of cargo 7 is in either the loading or unloading position. The light sensor 81a, 81b then transmits an electric switch signal to the evaluation unit, which in turn runs the evaluation and activates the electric motor 53 and the brake mechanism 63 of the drive roller 9. The light sensor 81a, 81b scans an item of cargo 7 being transported along the displacement path and detects the presence of an item of cargo 7 either in the loading or unloading position.

As indicated by broken lines in FIG. 5, the light sensors 81a, 81b are respectively connected to the frame 8 by means of a mounting holder 84 and are disposed to the side of the displacement path of the cargo 7 above the transport plane in the pulley region 37a, 37b. The front and rear edges 56a, 56b (FIG. 6) bounding the displacement path of the cargo 7 in the circumferential direction on the frame 8 act as stationary mechanical stops, which may be provided with damping elements. The sensors 80a, 80b are disposed in such a way in the circulation direction of the conveyor belt 11 that once the electric motor 53 has been switched off, the mass inertia of the item of cargo 7 alone moves it against the front or rear edge 56a, 56b into either the unloading or loading position. Naturally, the sensors 80a, 80b may be just as easily integrated in the frame 8, in particular the longitudinal members 14 or terminal members 17. As described above, the electric motor 53 may be controlled on the basis of a speed pattern whereby the item of cargo 7 runs softly against the front or rear edge 56a, 56b.

FIGS. 12 and 13, which will be described together, illustrate a detail of the loading compartment 2 and the loading compartment floor 5, which can be moved between a downwardly pivoted closed position, as illustrated in FIG. 12, and an upwardly pivoted open position, as illustrated in FIG. 13. The loading compartment floor 5, in particular the conveyor system 6, is articulatingly connected to the vehicle floor at its front end via a bearing part 85. The bearing part 85 has pin-type bearing shafts 86 at the front end of the conveyor system 6 on the frame 8 extending to the side in opposite directions and oriented parallel with the rotation axis 16 of the drive and guide roller 9, 10, which are mounted so as to be rotatable in bearing blocks 87 disposed at the two sides of the conveyor system 6. The loading compartment 2 has a depression 88, extending down away from the plane of the vehicle floor, in which a spare wheel 89, tool, such as a car jack, Allen keys and similar, or accessories and similar can be stowed. In a direction extending opposite the depression 88 up away from the plane of the vehicle floor is a thrust bearing 90 on which the conveyor system 6 is supported by means of the frame 8 when the conveyor system 6 is pivoted down into its closed position. The loading compartment floor 5 is disposed directly above the depression 88.

Although not illustrated, an operating handle is provided in the grip depression 49, by means of which a device for locking and unlocking the loading compartment floor 5 and the conveyor system 6 in the downwardly pivoted closed position may be integrated. In order to assist the muscular force needed to pivot the loading compartment floor 5 upwards, at least one actuator drive may be provided, although this is not illustrated, which may be provided in the form of a gas compression spring articulatingly connected to the frame 8 and the vehicle floor at the side.

In another embodiment, although this is not illustrated, the loading compartment floor 5 is mounted in the loading compartment 2 in a stationary bearing part to enable it to be displaced in a plane extending parallel with the loading surface 23 or transport plane. The bearing part in this embodiment is provided in the form of approximately U-shaped longitudinal rails disposed at the two longitudinal sides of the loading compartment floor 5 or frame 8, which laterally extend round the loading compartment floor 5 on the frame 8 at the side and mount it so that it can be displaced. The longitudinal rails extend in the vehicle longitudinal direction, starting from the loading opening 3 to below the seat frame of the rear seat 1. The loading compartment floor 5 may be pushed between the open position releasing the depression 88 and the closed position covering the depression 88 so that the spare wheel 89 can be easily removed when the depression 88 is in the open position.

If an item of cargo 7, for example a crate of drinks, has to be deposited in the loading compartment 2, it is placed on the loading surface 23 by the operator. By activating the forward switch 65, the conveyor belt 11 is moved in the loading direction—indicated by arrow 91—and the item of cargo 7 is thus moved in the direction towards the loading position close to the rear seat 1 until it is detected by the sensor 46a; 69a; 80a. When the forward switch 65 is activated, the conveyor belt 11 is circulated by the drive roller 9 and is driven until it is detected by the sensor 46a; 69a; 80a. When the presence of an item of cargo 7 is detected in the loading position, the sensor 46a; 69a; 80a transmits an electric switch signal to the evaluation unit, which in turn activates the electric motor 53 and/or brake mechanism 63 and thus stops the drive roller 9 and the cargo 7 from moving once in the loading position. In the loading position, the item of cargo 7 is supported against the sensor 46a or against the front edge 56a on the frame 8 and safely retained.

If the item of cargo 7 has to be removed from the loading compartment 2, the reverse switch 66 is activated, which prompts a control signal to be sent to the brake mechanism 63 and the electric motor 53 respectively by the control unit, and the brake mechanism 63 is moved into its basic position and the drive roller 9 is driven in the reverse direction and the conveyor belt 11 moved in the unloading direction—indicated by arrow 92—so that the item of cargo 7 is moved in the direction towards the unloading position until it is detected by the sensor 46b; 69b; 80b. Once the presence of the item of cargo 7 is detected in the unloading position, the electric motor 53 and/or the brake mechanism 63 receives a control signal triggered by the sensor 46b; 69b; 80b, as a result of which the electric motor 53 is stopped, the brake mechanism 63 is moved into its braking position and the item of cargo 7 is stopped from moving whilst in the unloading position.

On receipt of the switch signal from the sensor 46a, 46b; 69a; 69b; 80a, 80b after detecting the presence of an item of cargo 7 in either the loading or unloading position—the brake mechanism 63 is activated by the control unit by means of a brake signal and the drive roller 9 is stopped so that the item of cargo 7 can be reliably held in the position sitting against the sensor 46a, 46b; 69a, 69b; 80a, 80b or the front or rear edge 56a, 56b of the frame 8, even if the motor vehicle is accelerating or braking. By means of the sensors 46a, 46b; 69a, 69b; 80a, 80b, the item of cargo 7 is stopped relative to the loading compartment floor 5 or loading compartment 2 in a controlled manner.

In a preferred embodiment, the loading compartment floor 5 is a fully modular unit which can be preassembled and be fitted easily and rapidly in the motor vehicle and which also occupies a very small height. As a result, the loading compartment floor 5 may also be disposed on the rear face of a back rest of the rear seat 1, which can be folded forwards in order to make the loading compartment bigger. The unit as a whole may be manufactured inexpensively and preassembled.

Finally, it should also be pointed out that the guide roller 10 can be just as easily replaced by a slide body (pulley element) with a semicircular slide arch in the cross-section, around which the conveyor belt 11 is fed in the pulley region 37b. This slide may be provided as a separate component, which is mounted on the frame 8 by means of the clamping mechanism 41 so as to be relatively displaceable.

The invention may be also be used to advantage in loading compartments 2 of omnibuses, thereby facilitating access to the loading compartments 2 disposed underneath the passenger compartment, which extend across the entire width of the omnibus and are accessible from a longitudinal side of the omnibus.

For the sake of good order, it should be pointed out that in order to provide a clearer understanding of the loading compartment floor 5, it and its constituent parts are illustrated to a certain extent out of scale and/or on an enlarged scale and/or on a reduced scale.

Above all, the subject matter illustrated individually in FIGS. 1 to 9; 10, 11; 12, 13 may be construed as independent solutions proposed by the invention in their own right ad may be used in any combination.

While the invention has been particularly shown and described with reference to particular embodiments, it will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

### LIST OF REFERENCE NUMBERS

Rear seat 27 Guide element Loading compartment 28 Mounting slot Loading opening 29 Projection Rear door 30 Mounting slot Loading compartment floor 31 Guide rail Conveyor system 32 Guide surface Item of cargo 33 Guide part Frame 34 Guide element Drive roller 35 Guide surface Guide roller 36 Guide surface Conveyor belt 37a Pulley region Support surface 37b Pulley region Cover 38 Leg Longitudinal member 39a End Cross-member 39b End Rotation axis 40 Distance Terminal member 41 Clamping mechanism Terminal member 42 Cover portion Bridging section 43 Terminal portion Shaft portion 44 Connecting flange Shaft mount 45 Mounting groove Top strand 46a Sensor Loading surface 46b Sensor Slide surface 47 Reinforcing rib

Bottom strand 48 Top face WVall 49 Grip depression Distance 73 Mounting section portion Plug-in pin 74 Support section portion

External face 75 Switch section portion Electric motor 76 Switch surface Switch block 77 Switch Switch block 80a Sensor Gap region 80b Sensor Gap region 81a Light sensor Front edge 81b Light sensor Rear edge ⁸2a Reflector Fixing element 82b Reflector Switch body 83 Scanning beam Switch compartment 84 Mounting holder Contact region 85 Bearing part Contact region 86 Bearing shaft Switch surface 87 Bearing block Brake mechanism 88 Depression Control unit 89 Spare wheel Forward switch 90 Thrust bearing Reverse switch 91 Loading direction

Sensor 92 Unloading direction

Sensor

Switch block

Switch block

Bearing part

Shaft stub

Shaf body

What is claimed is:

1. A loading compartment floor for a loading compartment in a motor vehicle, the compartment floor comprising a conveyor system containing a drive roller, a guide roller and a conveyor belt continuously wrapped around the drive and guide rollers, and a means of detecting a loading and an unloading position of said conveyor system and a means of controlling the drive rollers, which are operatively disposed in pulley regions of the conveyor belt.

2. The loading compartment floor according to claim 1, wherein the conveyor belt comprises a transport plane or load carrying surface.

3. The loading compartment floor according to claim 1, wherein the means of detecting said loading and unloading positions comprise sensors.

4. The loading compartment floor according to claim 1, wherein the sensors are respectively disposed in a radial gap region between a frame of the conveyor system and an external face of the conveyor belt facing away from the drive and guide rollers.

5. The loading compartment floor according to claim 1, wherein a terminal member of the frame is disposed in the direction of a rotation axis of the drive and guide rollers.

6. The loading compartment floor according to claim 1, wherein the sensors are comprise optoelectronic sensor arrays.

7. The loading compartment floor according to claim 1, wherein the sensors comprise laser or infrared sensor arrays capable of projecting a scanning beam transversely across the conveyor system in the direction of the rotation axis of the drive and guide rollers.

8. The loading compartment floor according to claim 3, wherein the sensors are integrated in the frame or secured to it by means of mounting holders or secured in the loading compartment.

9. The loading compartment floor according to claim 4, wherein every sensor comprises a switch block projecting from the transport plane or load carrying surface of the conveyor belt, wherein a switch block surface projects into the gap region.

10. The loading compartment floor according to claim 9, wherein the switch block is retained on a bearing part which can be pivoted about an axis oriented in parallel with the rotation axis of the drive and guide rollers.

11. The loading compartment floor according to claim 9, wherein the switch block is secured to the frame.

12. The loading compartment floor according to claim 9, wherein the switch block comprises a switch body with an integral switch compartment and conductive contact regions separated from one another by the latter as well as an elastically deform able switch surface facing the conveyor belt.

13. The loading compartment floor according to claim 1, wherein the conveyor system has a frame on which stops are mounted projecting into the displacement path of an item of cargo.

14. The loading compartment floor according to claim 13, wherein the stops can be moved into said displacement path and limit the transport plane in the circulation direction of the conveyor belt, which are formed by front and rear edges provided on the frame.

15. The loading compartment floor according to claim 13, wherein the stops comprise damping elements in the region of the front and rear edges for at least partially absorbing impact energy on impact with the item of cargo.

16. The loading compartment floor according to claim 15, wherein the damping elements comprise switch blocks including a switch body made from an elastically flexible, reversible plastic, as for example, a thermoplastic.

17. The loading compartment floor according to claim 15, wherein the switch block extends essentially continuously across the width of the conveyor belt.

18. The loading compartment floor according to claim 1, wherein a top strand of the conveyor belt is supported on a slide surface which extends continuously between longitudinal members of the frame and the drive and guide rollers.

19. The loading compartment floor according to claim 1, wherein a sound-absorbing component, out of wood, a wood-based material, plastic or a composite material, such as a composite board, is secured to the frame between said top strand and a bottom strand of the conveyor belt.

20. The loading compartment floor according to claim 19, wherein the sound-absorbing component forms a slide surface for a top and/or bottom strand of the conveyor belt or is connected to the slide surface for a top and/or bottom strand of the conveyor belt.

21. The loading compartment floor according to claim 1, wherein the drive roller is coupled with an electric motor disposed inside the drive roller.

22. The loading compartment floor according to claim 1, wherein the drive roller has an electrically or electromechanically operated brake mechanism inside it.

23. The loading compartment floor according to claim 21, wherein the electric motor is connected to a control unit for controlling the circulation direction of the conveyor belt, which in turn is connected to a control unit of a motor vehicle power system.

24. The loading compartment floor according to claim 1, wherein the frame and the conveyor belt comprise mutually engaging guide elements with complementary, such as wedge-shaped or semicircular guide surfaces of which the first guide element on the frame is assigned to the top strand of the conveyor belt and extends continuously in parallel with the circulation direction between the drive and guide rollers, and the second guide element on the conveyor belt extends continuously in the circulation direction across the entire conveyor belt length.

25. A motor vehicle with a loading compartment and a loading compartment floor disposed in it, wherein the loading compartment floor is of a design according to claim 1.

26. The motor vehicle according to claim 25, wherein a depression is provided in the loading compartment in a plane extending underneath the loading compartment floor, preferably for a spare wheel, and the loading compartment floor is mounted in the loading compartment by means of a bearing part so that it can be moved between an open position releasing the depression and a closed position covering the depression.

27. The motor vehicle according to claim 25, wherein the loading compartment floor is mounted on a stationary bearing part in the loading compartment by its one end so as to be pivotable about a bearing shaft.

28. The motor vehicle according to claim 25, wherein the drive roller is disposed at the same end as the bearing shaft.

29. The motor vehicle according to claim 25, wherein the loading compartment floor is mounted in a stationary bearing part in the loading compartment so as to be displaceable in a plane extending in parallel with the transport plane.
